(19) United States
(12) Patent Application Publication
(10) Pub. No.: US 2021/0039175 A1
(43) Pub. Date: Feb. 11, 2021

(54) DRILL BIT AND DRILLING MACHINE

(71) Applicants: National University Corporation Tokai National Higher Education and Research System, Chikusa-ku, Nagoya-shi, Aichi (JP); DENSO DAISHIN CORPORATION, Tokoname-shi, Aichi (JP); DENSO CORPORATION, Kariya-city (JP)

(72) Inventors: Eiji SHAMOTO, Chikusa-ku, Nagoya-shi, Aichi (JP); Takehiro HAYASAKA, Chikusa-ku, Nagoya-shi, Aichi (JP); Hikaru AKARI, Chikusa-ku, Nagoya-shi, Aichi (JP)

(21) Appl. No.: 16/967,093

(22) PCT Filed: Feb. 1, 2019
(86) PCT No.: PCT/JP2019/003550

§ 371 Date: Aug. 3, 2020

(30) Foreign Application Priority Data
Feb. 6, 2018 (JP) 2018-019526

(51) Int. Cl. B23B 51/02

(52) U.S. Cl. CPC B23B 51/02

(57) ABSTRACT

A drill bit includes a cutting edge formed at a distal end of a drill bit body, a chip ejection flute having a rake face on a side adjacent to the distal end of the drill bit body, the chip ejection flute extending from the rake face toward a proximal end of the drill bit body, and a chip guide part provided, on the rake face, extending along an extending direction of the chip ejection flute. The chip guide part has at least one guide groove extending along the extending direction of the chip ejection flute from a ridge portion where the cutting edge is provided or from near the ridge portion.

### CROSS REFERENCE TO RELATED APPLICATIONS

This application is based upon and claims the benefit of priority from Japanese Patent Application No. 2018-19526, filed on Feb. 6, 2018, the entire contents of which are incorporated herein by reference.

### TECHNICAL FIELD

The present disclosure relates to a drill bit and a drilling machine.

### BACKGROUND ART

A helical chip ejection flute is provided on an outer peripheral surface of a drill bit body, and chip generated during cutting work comes into collision with an inner wall of the chip ejection flute to be broken and is then ejected from the chip ejection flute to the outside. At this time, the chip is broken in a three-dimensional curled state, and depending on the curled state, the chip may fail to be properly ejected from the chip ejection flute and then jam the chip ejection flute. In order to increase chip ejection efficiency, it is sufficient to increase a cross-sectional area of the chip ejection flute to enlarge a chip pocket, but a problem arises that leads to poor drill bit strength.

In particular, component holes have recently been reduced in diameter in response to a demand for weight reduction of components. Accordingly, drill bits to be used have also been reduced in diameter, and it has become increasingly difficult to increase the cross-sectional area of the chip ejection flute because of the necessity of ensuring enough drill bit strength. It is therefore required that, during cutting work, reciprocating feed or step feed motion be applied to eject chip from a drilled hole, but machining efficiency decreases due to an increase in non-machining time.

### CITATION LIST

### Patent Document

[patent document 1] JP S60-12648 Y

### SUMMARY OF THE INVENTION

### Problem to be Solved by the Invention

It is therefore desirable to develop a drill bit that allows highly efficient cutting work without causing chip to jam a chip ejection flute. The present disclosers believe that the chip ejection flute is jammed because the chip is broken in a three-dimensional curled state, and has conceived a drill bit that achieves high-efficiency machining with improved chip outflow behavior.

The present disclosure has been made in view of such circumstances, and it is therefore an object of the present disclosure to provide a drill bit having excellent chip ejection efficiency, and a drilling machine using the drill bit.

### Means to Solve the Problem

In order to solve the above-described problems, a drill bit according to one aspect of the present disclosure includes a cutting edge formed at a distal end of a drill bit body, a chip ejection flute having a rake face on a side adjacent to the distal end of the drill bit body, the chip ejection flute extending from the rake face toward a proximal end of the drill bit body, and a chip guide part provided, on the rake face, extending along an extending direction of the chip ejection flute.

A drilling machine according to another aspect of the present disclosure includes a rotary unit structured to rotate a drill bit or a workpiece, the drill bit having a chip guide part provided, on a rake face, extending along an extending direction of a chip ejection flute, and a treatment part structured to cut or collect linear chip ejected from the chip ejection flute of the drill bit.

Note that any combination of the above-described components, or an entity that results from replacing expressions of the present disclosure among a method, an apparatus, a system, and the like is also valid as an aspect of the present disclosure.

### BRIEF DESCRIPTION OF THE DRAWINGS

FIG. 1 is a diagram showing a structure of a drilling machine according to an embodiment.

FIG. 2 is a diagram showing an example of a structure of a drill bit.

FIG. 3 is an enlarged view of a chip guide part.

FIG. 4 is a diagram showing an example of a part of an A-A cross section of a rake face.

FIG. 5 is a view showing another example of the part of the A-A cross section of the rake face.

FIG. 6 shows an example of chip ejected as a result of drilling a hole.

### MODE FOR CARRYING OUT THE INVENTION

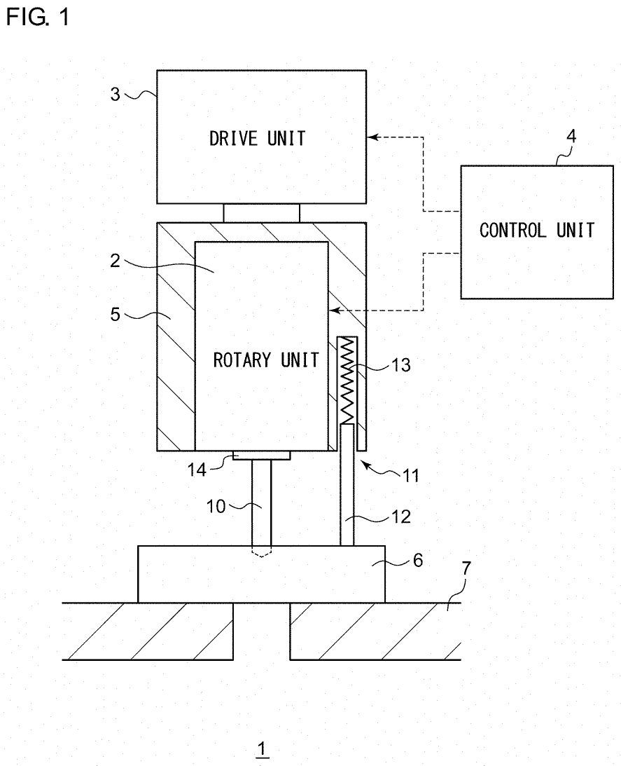

FIG. 1 shows a structure of a drilling machine 1 according to an embodiment. The drilling machine 1 includes a rotary unit 2 that rotates a drill bit 10, a drive unit 3 that vertically moves the rotary unit 2, a control unit 4 that controls the rotary unit 2 for rotation of the drill bit 10 and the drive unit 3 for vertical movement of the rotary unit 2, and a fixture 7 that secures a workpiece (to-be-cut object) 6. The drill bit 10 is held by a holder 14 secured to a spindle of the rotary unit 2. The rotary unit 2 is secured to an attachment member 5, and the drive unit 3 is connected to the attachment member 5 to vertically move the attachment member 5, thereby causing the rotary unit 2 to vertically move.

The drilling machine 1 according to the embodiment drills holes using the drill bit 10 that causes two-dimensional linear chip (swarf) of the workpiece 6 rather than three-dimensional curled chip to flow out to a chip ejection flute. The two-dimensional linear chip is ejected, without being broken, to the outside along the chip ejection flute that serves as a guide path. Therefore, the drilling machine 1 includes a treatment part 11 that cuts or collects the linear chip ejected from the chip ejection flute of the drill bit 10.

According to the embodiment, the treatment part 11 includes a cutting member 12 that cuts, at a position away from a drilled hole, the linear chip separated from the chip ejection flute by centrifugal force generated by the rotation of the drill bit 10. The cutting member 12 is held with being kept pressed by a pressing member 13 such as a spring to be movable upward and downward in a long hole formed in the attachment member 5, and a distal end of the cutting member 12 is kept in contact with the workpiece 6 or the fixture 7. During cutting work, the linear chip separated from the chip ejection flute by the centrifugal force comes into collision with the cutting member 12 and is then cut off.

Note that the treatment part 11 shown in FIG. 1 is structured to cut linear chip, or alternatively, may have a mechanism to wind linear chip to collect the linear chip, for example.

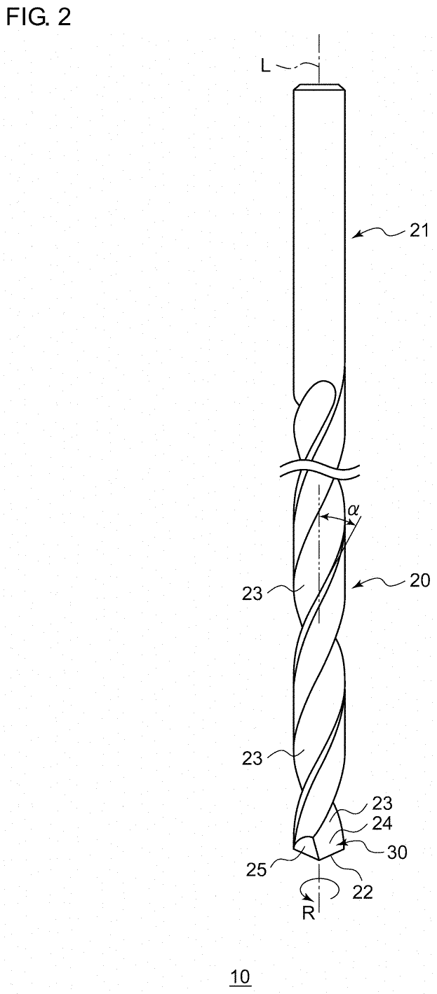

FIG. 2 shows an example of a structure of the drill bit 10. The drill bit 10 is a cutting tool for use in drilling of a hole in the workpiece 6, and includes a drill bit body 20 and a shank 21. In the example shown in FIG. 2, a part of the drill bit body 20 extending in a direction of an axis L is not shown. An arrow R denotes a rotation direction of the drill bit 10, and an angle α denotes a helix angle of the chip ejection flute 23.

The shank 21 is held by the holder 14, so that the drill bit 10 is attached to the drilling machine 1. A rotational force of the rotary unit 2 is transmitted to the shank 21 through the holder 14 to rotate the drill bit 10 about the axis L in the direction denoted by the arrow R.

The drill bit body 20 includes a cutting edge 22 formed at a distal end of the drill bit body 20, and the chip ejection flute 23 having a rake face 24 on a side adjacent to the distal end of the drill bit body 20, the chip ejection flute 23 extending from the rake face 24 toward a proximal end of the drill bit body 20. Two cutting edges 22 are symmetrically provided at the distal end of the drill bit body 20, and two helical chip ejection flutes 23 corresponding to the two cutting edges 22 are formed on an outer peripheral surface of the drill bit body 20. The chip ejection flute 23 has the rake face 24 of the cutting edge 22 on the distal end side and is capable of ejecting chip generated by the cutting edge 22 during cutting work from a drilled hole to the outside.

A flank 25 is provided to reduce a contact area between the distal end of the drill bit body 20 and the workpiece 6 during cutting work to suppress cutting resistance. The cutting edge 22 is formed at a ridge portion between the flank 25 and the rake face 24.

Normal drilling work causes chip to have an upward curl and a lateral curl. The upward curl is a curl around an axis parallel to the cutting edge 22 and is generated by friction between the chip and the rake face. The lateral curl is a curl around a normal to the rake face and is generated due to a difference in velocity between inner and outer diameters of the cutting edge 22. In particular, the drill bit 10 has the cutting edge 22 extending from an approximately center to outer diameter of the drill bit, thereby making the diameter of the lateral curl approximately identical to the diameter of the drill bit and thus generating a large lateral curl. When chip has an upward curl and a lateral curl, the chip is generated in a three-dimensional curled shape from the cutting edge 22, so that the chip comes into collision with the inner wall of the chip ejection flute and is then broken, and particularly when the hole is deep and the chip ejection flute is narrow, the chip may jam in the flute.

Therefore, the drill bit 10 according to the embodiment includes a chip guide part 30 provided, on the rake face 24, extending approximately along the extending direction of the chip ejection flute 23. The chip guide part 30 is preferably provided extending in a direction that coincides with the extending direction of the chip ejection flute 23, or alternatively, may be provided extending in a direction that approximately coincides with the extending direction. The direction that approximately coincides with the extending direction includes a direction having an angle of, for example, within 20 degrees relative to the extending direction of the chip ejection flute 23. The chip guide part 30 suppresses curling in generated chip and restricts a chip outflow direction. The chip guide part 30 may include at least one groove formed by cutting out the rake face 24, or alternatively, may include at least one groove formed of at least two ridges provided on the rake face 24.

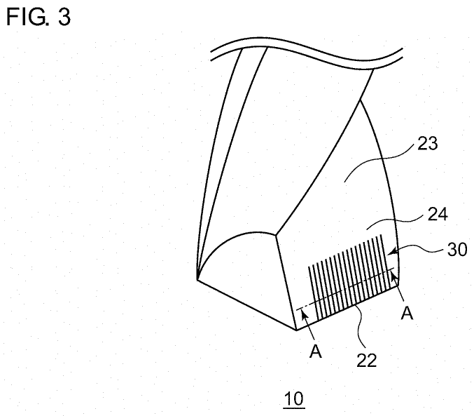

FIG. 3 shows an enlarged view of the chip guide part 30. As shown in FIG. 3, the chip guide part 30 is provided, on the rake face 24, extending approximately along the extending direction of the chip ejection flute 23, and includes at least one guide groove extending approximately along the extending direction of the chip ejection flute 23 from the ridge portion where the cutting edge 22 is provided or from near the ridge portion.

The chip guide part 30 formed on the rake face 24 of the drilling machine 1 causes, when the cutting edge 22 cuts the workpiece 6, plastically deformed portion of the chip that comes into contact with the rake face 24 to fit into the guide groove of the chip guide part 30 and guides the chip fitted into the guide groove to the outside in a direction in which the guide groove extends. At this time, the lateral curl is suppressed because the plastically deformed portion is fitted into the guide groove, and the upward curl is suppressed because the chip having a shape transferred from the guide groove is prevented from being flat and has bending resistance in a direction in which the upward curl occurs. As a result, two-dimensional chip, that is, linear chip that is larger in width than the guide groove, flows out in the extending direction of the guide groove, that is, in the direction that approximately coincides with the extending direction of the chip ejection flute 23. This allows the linear chip to continuously flow out along the chip ejection flute 23 and thus prevents the linear chip from jamming the chip ejection flute 23.

In order to effectively suppress the upward curl and the lateral curl, the chip guide part 30 preferably includes a plurality of guide grooves between both ends of the cutting edge 22. FIG. 3 shows the chip guide part 30 including a plurality of guide grooves at equal intervals, but the intervals between the plurality of guide grooves need not be equal intervals. Note that the guide groove in the chip guide part 30 is preferably formed at least adjacent to a chip center so as to increase the curl suppressing effect and the outflow direction restricting effect.

Further, in order to increase the curl suppressing effect and the outflow direction restricting effect, it is preferable that the guide groove be formed deeper than twice a chip thickness. Further, the guide groove is preferably formed longer than a chip contact length (for example, about three times as long as a cutting width). Note that the guide groove may be shorter than the contact length, but in that case, in order to prevent the guide groove from impeding the outflow, it is preferable that the guide groove be gradually shallower as away from the cutting edge 22.

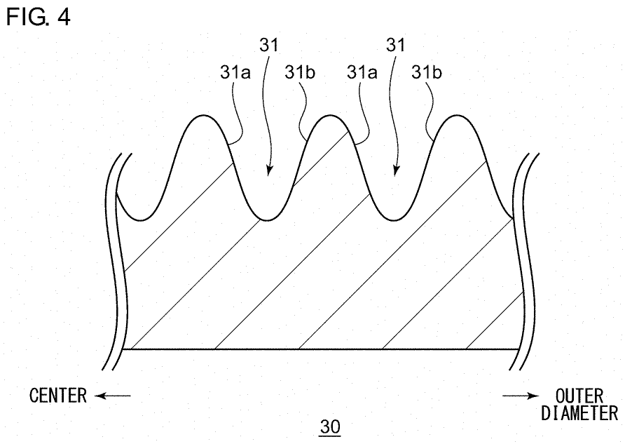

FIG. 4 shows an example of a part of an A-A cross section of the rake face 24. The chip guide part 30 includes a plurality of guide grooves 31 provided in parallel with each other. Each of the guide grooves 31 is formed to have a first groove portion 31a on a radially inner side (center side) and a second groove portion 31b on a radially outer side (outer diameter side). The first groove portion 31a and the second groove portion 31b form an approximately symmetrical shape so as to avoid becoming a steep slope; therefore, the chip has resistance to a breaking in the width direction, and the drill bit 10 is easily manufactured. For example, the chip guide part 30 may have a sinusoidal cross-sectional shape.

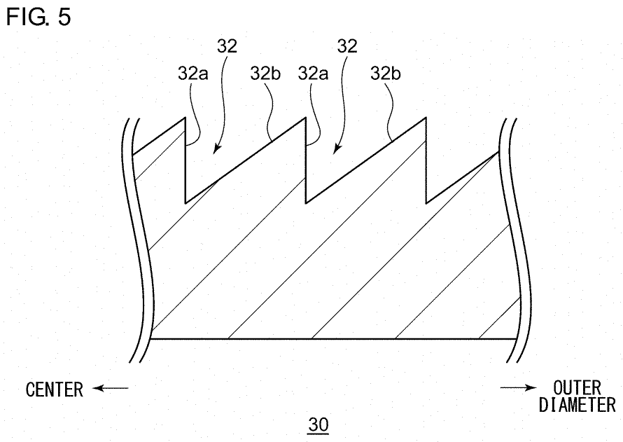

FIG. 5 shows another example of the part of the A-A cross section of the rake face 24. The chip guide part 30 includes a plurality of guide grooves 32 provided in parallel with each other. Each of the guide grooves 32 is formed to have a first groove portion 32a on the radially inner side (center side) and a second groove portion 32b on the radially outer side (outer diameter side). In the guide groove 32, the first groove portion 31a and the second groove portion 31b form an asymmetrical shape. In this example, the first groove portion 32a is formed extending in a direction approximately perpendicular to the rake face 24. The first groove portion 32a serving as a wall extending in the direction approximately perpendicular to the rake face 24 can effectively suppress the lateral curl of the chip and effectively restrict the outflow direction of the chip.

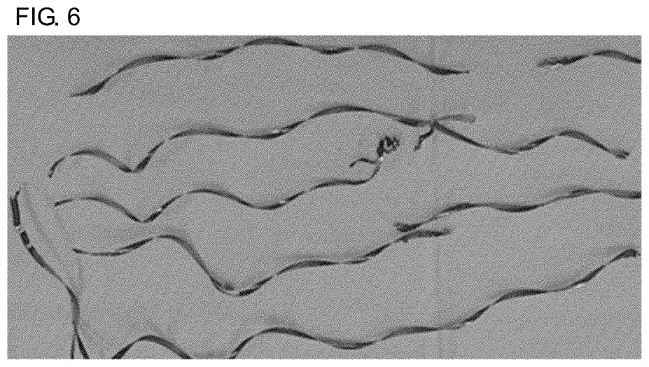

FIG. 6 shows an example of the chip when a hole is drilled using the drill bit 10 including the guide groove 32 shown in FIG. 5. In this example, chip when the feed speed of the drill bit 10 is changed is shown, and the chip has a two-dimensional linear shape and is ejected from the drilled hole without jamming the hole.

As described above, the chip guide part 30 causes the chip to linearly flow out in the extending direction of the chip ejection flute 23, allowing a hole to be drilled without causing the chip to jam the hole. Further, since the chip moves in the chip ejection flute 23 without being broken, the drill feed speed that directly affects machining efficiency can be increased as long as the drill bit strength practically allows. Further, since less-curled straight chip has a two-dimensional shape and is thus not bulky, the cross-sectional area of the chip ejection flute 23 can be reduced, and the drill bit strength can be increased.

The present disclosure has been described on the basis of the embodiment. It is to be understood by those skilled in the art that the embodiment is illustrative and that various modifications are possible for a combination of components or processes, and that such modifications are also within the scope of the present disclosure.

The drilling machine 1 according to the embodiment causes the rotary unit 2 to rotate the drill bit 10, but the drilling machine 1 according to a modification may cause the rotary unit 2 to rotate the workpiece 6 with the drill bit 10 fixed.

An outline of aspects of the present disclosure is as follows. One aspect of the present disclosure relates to a drill bit including a cutting edge formed at a distal end of a drill bit body, and a chip ejection flute having a rake face on a side adjacent to the distal end of the drill bit body, the chip ejection flute extending from the rake face toward a proximal end of the drill bit body. The drill bit includes a chip guide part provided, on the rake face, extending along an extending direction of the chip ejection flute. Note that the chip guide part provided extending along the extending direction of the chip ejection flute may include a chip guide part provided extending approximately along the extending direction of the chip ejection flute without departing from the intended purpose.

According to this aspect, the chip guide part provided on the rake face allows the chip to flow out approximately in the extending direction of the chip ejection flute.

The chip guide part preferably has at least one groove extending along the extending direction of the chip ejection flute from a ridge portion where the cutting edge is provided or from near the ridge portion. The groove extending along the extending direction of the chip ejection flute may include a groove extending approximately along the extending direction of the chip ejection flute. The chip guide part preferably has a plurality of grooves between both ends of the cutting edge. The chip guide part having a plurality of grooves can stabilize an outflow direction of the chip and further suppress curling in the chip.

Each of the grooves has a first groove portion formed on a radially inner side and a second groove portion formed on a radially outer side. At this time, the first groove portion and the second groove portion may form a symmetrical shape. Herein, the symmetrical shape may include an approximately symmetrical shape without departing from the intended purpose. Further, the first groove portion and the second groove portion may form an asymmetric shape, and the first groove portion may be formed extending in a direction approximately perpendicular to the rake face.

Another aspect of the present disclosure relates to a drilling machine including a rotary unit structured to rotate a drill bit or a workpiece, the drill bit having a chip guide part provided, on a rake face, extending along an extending direction of a chip ejection flute, and a treatment part structured to cut or collect linear chip ejected from the chip ejection flute of the drill bit. Note that the chip guide part provided along the extending direction of the chip ejection flute may include a chip guide part provided approximately along the extending direction of the chip ejection flute.

### DESCRIPTION OF THE REFERENCE NUMERALS

1 drilling machine, 2 rotary unit, 3 drive unit, 10 drill bit, 11 treatment part, 12 cutting member, 13 pressing member, 20 drill bit body, 22 cutting edge, 23 chip ejection flute, 24 rake face, 25 flank, 30 chip guide part, 31 guide groove, 31a first groove portion, 31b second groove portion, 32 guide groove, 32a first groove portion, 32b second groove portion

### INDUSTRIAL APPLICABILITY

The present disclosure is applicable to drill bits.

1. A drill bit comprising:
a cutting edge formed at a distal end of a drill bit body;
a chip ejection flute having a rake face on a side adjacent to the distal end of the drill bit body, the chip ejection flute extending from the rake face toward a proximal end of the drill bit body; and
a chip guide part provided, on the rake face, extending along an extending direction of the chip ejection flute.

2. The drill bit according to claim 1, wherein
the chip guide part has at least one groove extending along the extending direction of the chip ejection flute from a ridge portion where the cutting edge is provided or from near the ridge portion.

3. The drill bit according to claim 2, wherein
the chip guide part has a plurality of grooves between both ends of the cutting edge.

4. The drill bit according to claim 1, wherein
each of the grooves has a first groove portion formed on a radially inner side and a second groove portion formed on a radially outer side, and
the first groove portion and the second groove portion form a symmetrical shape.

5. The drill bit according to claim 1, wherein
each of the grooves has a first groove portion formed on a radially inner side and a second groove portion formed on a radially outer side, and
the first groove portion is formed extending in a direction approximately perpendicular to the rake face.

6. A drilling machine comprising:
a rotary unit structured to rotate a drill bit or a workpiece, the drill bit having a chip guide part provided, on a rake face, extending along an extending direction of a chip ejection flute; and
a treatment part structured to cut or collect linear chip ejected from the chip ejection flute of the drill bit.
